(19) United States
(12) Patent Application Publication
(10) Pub. No.: US 2014/0236960 A1
(43) Pub. Date: Aug. 21, 2014

(54) System and Method for Database Searching

(71) Applicant: FutureWei Technologies, Inc., Plano, TX (US)

(72) Inventors: Alexander Russakovsky, Palo Alto, CA (US); Sergey Golovko, Sunnyvale, CA (US)

(21) Appl. No.: 14/184,582

(22) Filed: Feb. 19, 2014

Related U.S. Application Data
(60) Provisional application No. 61/766,299, filed on Feb. 19, 2013.

(51) Int. Cl. G06F 17/30

(52) U.S. Cl. CPC G06F 17/30424; G06F 17/30321
USPC 707/741; 707/769

(57) ABSTRACT

In one embodiment, a method for searching a database includes receiving, by a processor from a user, a message, indicating a query, where the query comprises a pattern and determining, by the processor, a first threshold in accordance with a data set of the database. The method also includes comparing, by the processor, the pattern to a first key of the data set to produce a comparison and determining, by the processor, whether to jump to a second key of the data set or scan to a third key of the data set in accordance to the comparison and the first threshold including jumping to the second key of the data set when an absolute value of the comparison is greater than the first threshold, and scanning to the third key of the data set when the absolute value of the comparison is less than or equal to the first threshold, where the first key and the third key are sequential.

This application claims the benefit of U.S. Provisional Application Ser. No. 61/766,299 filed on Feb. 19, 2013, and entitled “System and Method for a Fast Key Pattern Search for a Multidimensional Database Index,” which application is hereby incorporated herein by reference.

### TECHNICAL FIELD

The present invention relates to a system and method for databases, and, in particular, to a system and method for database searching.

### BACKGROUND

Modern data warehouses often contain trillions of records, each containing multiple attributes. Business intelligence tasks, such as analytic queries, online analytic processing (OLAP), data mining, etc., should relatively quickly obtain answers to ad-hoc analytic queries against the data. Because of the volume of data, additional indexing is problematic, and such queries are answered using a full scan of data. Even when data is distributed in a cluster, a full scan may take a long time. Classical relational data warehouse techniques are often combined or replaced with non-relational distributed processing systems. Scalability and performance requirements are critical for business intelligence applications.

### SUMMARY

An embodiment method for searching a database includes receiving, by a processor from a user, a message, indicating a query, where the query comprises a pattern and determining, by the processor, a first threshold in accordance with a data set of the database. The method also includes comparing, by the processor, the pattern to a first key of the data set to produce a comparison and determining, by the processor, whether to jump to a second key of the data set or scan to a third key of the data set in accordance to the comparison and the first threshold including jumping to the second key of the data set when an absolute value of the comparison is greater than the first threshold, and scanning to the third key of the data set when the absolute value of the comparison is less than or equal to the first threshold, where the first key and the third key are sequential.

Another embodiment method for searching a database includes receiving, by a processor from a user, a message indicating a query, where the query includes a pattern and comparing, by the processor, the pattern to a first key of a data set of the database to produce a comparison. The method also includes logging, by the processor, a result in accordance with the comparison to produce a logged result and determining, by the processor, whether to jump or scan sequentially in accordance with the comparison. Additionally, the method includes transmitting, by the processor to the user, the logged result.

An embodiment computer includes a processor and a database including a multidimensional database index. The computer also includes a computer readable storage medium storing programming for execution by the processor. The programming including instructions to receive, from a user, a message, where the message indicates a query, and where the query includes a pattern and determine a first threshold in accordance with a data set of the database. The programming also includes instructions to compare the pattern to a first key of the data set to produce a comparison. Additionally, the programming includes instructions to determine whether to jump to a second key of the data set or scan to a third key in the data set in accordance to the comparison and the first threshold, including jump to the second key of the data set when an absolute value of the comparison is greater than the first threshold, and scan to the third key of the data set when the absolute value of the comparison is less than or equal to the first threshold, where the first key and the third key are sequential.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates examples of gz-curves;

FIG. 2 illustrates a mask projected onto coordinate vectors;

FIG. 3 illustrates an embodiment structure of the solution locus for a point pattern search problem (PSP);

FIG. 4 illustrates an embodiment structure of the solution locus for a range PSP;

FIG. 5 illustrates a flowchart for an embodiment method of database searching;

FIG. 6 illustrates a graph of query time for crawler and grasshopper strategies for several combinations of filters;

FIG. 7 illustrates a graph of query time for crawler and grasshopper strategies for different data stores;

FIG. 8 illustrates a graph of query time for crawler and grasshopper strategies for a call detail record (CDR) data set;

FIG. 9 illustrates a graph of query time for crawler and grasshopper strategies for a Transaction Processing Performance Council Decision Support (TPC-DS) data set;

FIG. 10 illustrates another graph of query time for crawler and grasshopper strategies for a TPC-DS data set; and

FIG. 11 illustrates a block diagram of an embodiment general-purpose computer system.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Multidimensional databases used in data warehousing transform customer data into key value pairs using dictionaries and specific key composition. Key value pairs may be stored in the order of the keys. The multidimensional space of all possible keys is equipped with a space-filling curve so each possible key corresponds to a single point on the curve. Such points are parameterized with very large integers. Queries with point, range, or set filters on any attribute and multiple combinations of such attributes against customer data is translated into a pattern search problem on the composite keys.

Embodiments perform fast subset filtering within ordered sets of integers representing composite keys. An embodiment may be used to accelerate ad-hoc analytic queries against a data warehouse without addition indexing. Embodiments may be used for point, range, and set restrictions on multiple attributes in any combination. Point filters are equality restrictions, range filters are interval restrictions, and set filters are subset restrictions. A combination of sequential crawling with jumps over large portions of irrelevant keys is used. The decision to jump may be adaptively determined from characteristics of the underlying data store.

An ad-hoc online analytic processing (OLAP) query is a query in which various filters may be placed on some of the participating variables and measure values may be aggregated. OLAP implementations may use dictionaries to encode dimensional attribute value with consecutive integers. For ordered attributes with surrogate keys, surrogate keys may be integers. For unordered attributes, the integers may be consecutive. For ordered attributes, the ordering may be preserved.

The Cartesian product of the dimensional attribute domains forms the composite key space. The vector dependency F then maps a composite key to a vector containing measures. Multidimensional database techniques are based on endowing the composite key space with a space filling curve, so that each element of the space corresponds to a single point on the curve, and vice versa. There are multiple ways to choose such a curve. In one example, a generalized z-curve (gz-curve) is used. In a gz-curve, each point on the curve is encoded with an integer that is derived from the values of the components of the composite key. Any query with point, range, or set filters against the cube translates into a pattern search problem on the gz-curve.

In an OLAP field, there is a vector functional dependency:

F:(D₁ . . . D_{N})→(M₁ . . . M_{M}).

Independent variables Dᵢ are dimensions (dimensional attributes) and dependent variables Mᵢ are measures. This dependency is augmented with additional functional dependencies involving dimensional attributes. Dependent attributes are higher level dimensional attributes. They induce groupings within domains of the attributes they depend on, and hence aggregation operations on measures. Dependencies may form a directed acyclic graph (DAG).

The dimensional attributes may be encoded with integers. If the attribute is integer valued, it can be used without additional encoding. If the attribute is not an integer value, an encoding dictionary is created. For attributes which are naturally ordered, encoding preserves the order. Dense encoding by consecutive integers may be used. Alternatively, dense encoding is not used. In one example, the cardinality of each dimensional attribute is a power of two.

Dimensional attributes are then expressed in encoded terms, for example as integers or arrays of bytes. The dictionaries and dependencies may provide a constant lookup time.

The dimensional attributes of interest may participate in the formation of a composite key. Including higher level attributes in the key may add sparsity to the model, but may eliminate the need for joins at the time of query.

Encoding with a composite key transforms the data for functional dependency F into a key-value format. A storage component is responsible for maintaining data in a key-value format and retrieving relevant key-value pairs at query time.

A simple query against the cube restricts certain attributes to a subset of their values and requests data satisfying the restrictions. In one example, there is a class of restrictions on dimensional attributes, for example, to point, range, and set restrictions on the attributes' domains.

When a query arrives, the system looks up the attribute values involved in the restriction against the dictionary and translates them into integers. These integers are then used to form restrictions on the composite key. They are passed to the storage component for retrieving relevant key-value pairs, which are aggregated and stored. Finally, dictionaries are used again to translate final results back to original attribute domain.

No matter how the composite key is produced, it provides integer encoding of the potential points in the key search space which is a Cartesian product of the encoding attribute domains. Thus, the composite key provides integer parameterization for a space filling curve in the search space. In an example, the integer composite key in binary representation is built from bits of participating components' keys, so that the order of bits of each component is preserved. This procedure produces keys of fixed length.

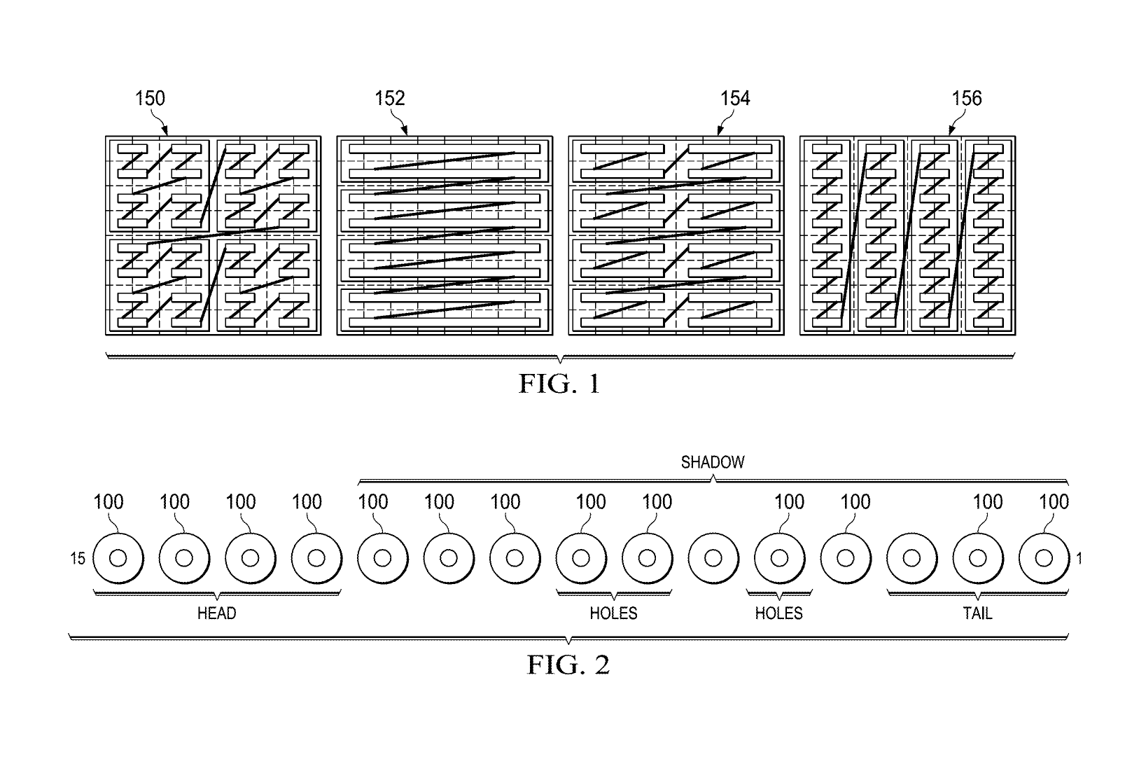

The shape of the gz-curve depends on the way component's bits are shuffled into the composite key. FIG. 1 illustrates some shapes for two variables, where bits for horizontal and vertical dimensions are marked with x and y, respectively. Curve 150 shows the classical isotropic z, curve, with bit orderings yxyxyx. Curve 152 shows an odometer curve, with bit ordering yyyxxx corresponding to sorting the keys by y, then by x. The odometer curve strongly favors one dimension over the other. Answers to queries with filters on the leading dimension(s) of the odometer are located within a single contiguous segment of the curve, whereas, for filters on the trailing dimensions they are scattered across the curve. Curve 154 shows a bit ordering yyxyxx, and curve 156 shows bit ordering xxyyyx. In FIG. 1, shaded areas are examples of fundamental regions of order 4.

Example methods apply to any combination of point, range, and set filters on any subset of dimensions, not necessarily on the full set. The methods may improve performance of ad-hoc OLAP queries for any underlying key-value storage system that keeps data in the order of the composite keys and supports certain simple operation. Significant performance gains may occur when the storage system efficiently supports the required operation. A method basically has in possession only certain characteristics of the storage, such as the ratio of sequential access and random access costs. Given a query, a certain threshold is computed, beyond which it will jump if it encounters an appropriate obstacle while crawling. The threshold may be determined algebraically and explained geometrically.

An example has little knowledge about the storage system, but has the ability to jump. It may jump over keys within the same unit of storage, or it may jump landing on a different unit of storage. Additional information provided by the data storage, such as the boundaries of the partitions by key intervals on the gz-curve may be used. These partitions may correspond e.g. to pages of the UB-Tree or HBase regions. Partitioning may be hierarchical and specific to the storage. The method may then decide whether to examine the contents of the region or to skip it. Each partition may be processed in parallel, for example with HBase regions. Moreover, within the partition, the dimensionality of the problem may be reduced. Then, the method may operate directly on the reduced factorized keys, without restoring the original keys.

A point restriction on one or more of the attributes involves fixing a pattern of bits in the key so the query problem translates into a fixed pattern search problem (PSP) on a set of keys. Range and set restrictions result in more complex patterns. If n is the total number of bits in the composite key, the space of all keys S is [symbol] ₂ⁿ, an n-dimensional linear space over the group of residues;

[symbol]

₂={0,1}.

The bits form an ordered basis e₁, . . . , eₙ in S and elements of S are ordered lexicographically by coefficients, which trivially coincides with the order of integers.

In one example, a bit-masking operator on a set of integers in binary representation with at most n binary digits are used. In another example, a set of functions extract calendar parts from calendars, where calendars represent a date and time. In an additional example, odometers, such as multi-resolution measurements systems, are used. Alternatively, time series, Fourier transforms, or wavelet transforms are used.

A mask is an operator of projection onto a d-dimensional coordinate linear subspace S. Given d basis vectors eᵢ₁, . . . , e_{id}, operator m masks out the remaining n−d coordinates. S(m) denotes the subspace onto which the mask m projects. Two or more masks are disjoint if the subspaces onto which they project are pairwise disjoint, that is, they do not have any common basis elements.

For gz-curves, a mask m_{D} corresponds to each dimensional attribute D. The mask defines its bit positions in the composite key. Applying the mask to the composite key retrieves the contributing value of D. Masks corresponding to different dimensional attributes are disjoint.

A is a subset of S representing composite keys of the cube fact data. Any query against the cube with point filter D=p on attribute D translates into a pattern search problem (P): find all x∈A such that x&m_{D}=p. Queries with point filters Dᵢ=pᵢ on multiple attributes Dᵢ translate into a similar problem of finding solutions to x&m=p, for the union m of attribute masks and union p of corresponding patterns.

Any mask on S may be considered to correspond to some virtual attribute. Thus, a query with multiple point filters is equivalent to a query with a single point filter on an appropriate virtual attribute.

A query with range filter D∈[a,b] also translates to a PSP (R): find all x∈A such that x&m_{D}∈[a,b]. However, unlike the point case, combining two or more such queries into a single similarly expressed query against some virtual attribute may be problematic. Elements may simultaneously satisfy some number of patterns.

Set queries are transformed in a similar manner. Given a set E={aᵢ, . . . , a_{N}}, the filter D∈E corresponds to the PSP (S): x&m_{D}∈E. The filters for multiple attributes may be combined into a similarly expressed query against some virtual attribute. Since the resulting restriction set is a Cartesian product of coordinate restrictions, its cardinality may be too large for practical purposes, so multi-pattern search may be used for them as well. Any solution to the search condition also satisfies a range of restrictions x&m_{D}∈[min(E), max(E)].

One solution to the pattern search problem on a set A⊂S is achieved via checking pattern restrictions on each element A in a full scan. A solution to the pattern search problem may be called efficient if, on average, it is faster than the brute force solution and it is never slower than the brute force solution. The average is with respect to a set of random pattern restrictions on any fixed combination of the appropriate number of attribute restrictions, and then over all such combinations. According to this definition, an efficient algorithm is allowed to lose to the full scan on some patterns, but is not allowed to lose on average.

A set X⊂S is factorizable if it can be represented as a Cartesian product of at least two subsets of S. Besides S itself, the set of all its elements satisfying a restriction of kind (P) is factorizable. For restrictions of kind (R) and (S), examples of factorizable subsets include intervals with common prefix or sets with common patterns.

{Sⱼ} is a partition of S into factorizable subsets, for example each with its own factors. The induced partition of any A⊂S by sets Aⱼ=A∩Sⱼ is also factorizable.

An example grasshopper method provides an additional advantage when dealing with factorizable partitions, in particular with partitions by key intervals or sets with common patterns. An example method may be especially efficient when the underlying storage implements prefix or common pattern compression.

An example grasshopper method avoids performing a full scan of the data by combining sequential crawling with jumps over large portions of irrelevant keys. To be applicable to any underlying data structure, powers are split between the devices used in the pattern search, the data store and the pattern matcher.

A key-value store may contain key-value pairs whose keys are elements of A⊂S. A data store is basic if it supports get, scan, and seek operations. A get operation is provided with a key in x∈A and retrieves an appropriate value. A scan operation is provided with a key x∈A and retrieves the next key in A. The seek operation is provided with a key in x∈S and retrieves the next key in A larger than or equal to x. Statistics for A, such as cardinality, first, and last key, may be available at a negligible cost. A partitioned data store may be able to provide partitioning criteria and to possess the elements of a basic data store for each element of the partition.

A matcher assists with the pattern search and has the functionality to perform a match operation, a mismatch operation, and a hint operation. A match operation is, for x∈S, tell whether x satisfies the given pattern restrictions. A mismatch operation is, for x∈S, return 0 if x satisfies the given pattern restrictions or the signed position of the highest bit in x responsible for mismatch, with the sign indicating whether the mismatch is from above or below. A hint operation is for an element x∈S with a mismatch y, suggest the next element h∈S, h>x, that can theoretically satisfy the pattern restrictions.

The operation of the store and the matcher are distinct. The store knows everything about the set A, but nothing about the masks and patterns. On the other hand, the matcher knows everything about the masks and patterns, and nothing about the set A. For different embodiments, there are variations in the matcher.

To search for a query in a data store crawler, frog, and grasshopper methods collect data matching a given set of patterns and place the matches into a bag. The crawler, frog, and grasshopper are each given a matcher. Using the matcher, they can compute the theoretical query bounding interval [PSPₘᵢₙ, PSPₘₐₓ] on S and intersect it with the interval [min(A), max(A)] to obtain the actual bounding interval [a, b].

The crawler scans sequentially. Example crawler pseudocode is:

bag = 0; x = a;
while x ≦ b {

if Match(x), add (x, Get(x)) to bag;
x = Scan(x);

}

The frog jumps as soon as possible. Example frog pseudocode is:

bag = 0; x = a;
while x ≦ b {

y = Mismatch(x)
if y = 0, add (x, Get(x)) to bag, x = Scan(x);
else x = Seek(Hint(x, y));
}

The grasshopper jumps only when the absolute value of the mismatch is above a threshold t. If the absolute value of the mismatch is not above the threshold t, the grasshopper crawls. Example grasshopper pseudocode is:

bag = 0; x = a;
while x ≦ b {

y = Mismatch(x)
if y = 0, add (x, Get(x)) to bag, x = Scan(x);
else if |y| ≦ t, x=Scan(x);
else x = Seek(Hint(x, y));
}

When the hint operation has nothing to suggest, it returns ∞, and the corresponding loop terminates.

A cost model for scanning methods may be developed. All three methods perform the same number of scan and get operations for those x that do match the PSP restrictions, so they may be excluded from the cost estimates. For elements that do not solve the PSP, the crawler performs match and scan operations, the frog performs mismatch, hint, and seek operations, and the grasshopper sometimes performs match and scan operations and other times performs mismatch, hint, and seek operations. Assuming the matcher's operations take negligible time compared to the data store's operation, the crawler's cost is N₀·cost(Scan), the cost of the frog is N₁·cost(Seek), and the grasshopper's cost is N₂·cost(Seek)+N₃·cost(Scan), where N₀ is the number of mismatched elements, N₁ is the number of the frog's jumps, N₂ is the number of the grasshopper's jumps, and N₃ is the number of times the grasshopper crawl.

R may be defined as:

$$R = \frac{cost ( scan )}{cost ( seek )} .$$

R is a property of the data store which may be determined experimentally.

The frog will finish ahead of the crawler if N₁<N₀·R. The term N₀ may be estimated from the corresponding selectivity distributions for values of participating attributes. However, a rough estimate of N₀ is:

card(A)·(1−2^{d-n}).

Thus, the frog is better if:

N₁<R·card(A)·(1−2^{d-n}).

The right hand side of this equation does not depend on the geometry of the mask(s), i.e. on the way the attributes participate in the key composition. By contrast, N₁ is heavily dependent on the mask.

If the grasshopper determines in advance that the frog is guaranteed to win over the crawler, it can set a threshold value t=0 to act as the frog. However, there are cases where the frog definitely loses to the crawler, for example if the mask consists only of the first bit, every second point of S solves the PSP. The matcher cannot propose anything better than jumping exactly to the next point, a losing strategy.

If the grasshopper determines that the crawler will always win, it can set the threshold value t=n, preventing any jumps. However, this strategy does not meet the efficiency criteria.

For a mask m, there is a complementary mask, or co-mask ^{˜}m that projects onto the remaining n−d coordinates. Any n-dimensional vector x may be restored from its projections onto S(m) and S(˜m), that is:

x=m(x)|^{˜}m(x).

The co-mask definition may be extended to complement a set of masks m₁, . . . , mₖ, with a subspace orthogonal to the span of S(mᵢ).

Mask m may be projected onto bits eᵢ₁, . . . , e_{id} in S(m) in ascending order. The tail(m) is defined as eᵢ₋₁ and the head(m) is defined as i_{d}. Mask m is contiguous if it projects onto adjacent bits, or, equivalently, if head(m)=tail(m)+d.

FIG. 2 illustrates some terminology. Dots 100 represent coordinate vectors from right to left. Mask m projects onto coordinates 4, 6, 9, 10, and 11. Coordinates 1-3 make up the tail, coordinates 12-15 make up the head, and coordinates 5, 7, and 8 form holes.

For a mask m and an element eᵢ of the basis of S, m>i, m=i, and m<i are projections of m onto basis vectors eᵢ₊₁, . . . , eₙ, eᵢ, and eᵢ, . . . , eᵢ₋₁ respectively. Thus:

m=m_{>i}|m₌ᵢ|m_{<i},

with similar relationships for the projection spaces. One or more of the projections may be empty. Similarly, a pattern p may be decomposed as:

p=p|p₌ᵢ|p_{<i}.

An element of a subspace T⊂S all of whose coordinates are 0 (1) is denoted 0_{T} (1_{T}). 0ₘ is used for 0_{S(m)}.

A partial order on the set masks is defined as:

m₁>m₂ [symbol] tail(m₁)≧head(m₂).

Among partitions of mask m by contiguous masks, a canonical partition of m is the one with the smallest number of parts. They are listed in descending order, from senior bits to junior bits.

The smallest element PSPₘᵢₙ matching a fixed pattern p in S is of the form 0˜ₘ|p and the largest such element, PSPₘₐₓ, is 1˜ₘ|p. These elements form the bounding interval for the fixed pattern search problem. Although they depend on p, their difference, spread(m, PSP) does not. That is, spread(m, PSP)=1˜ₘ|0.

For a range or set pattern restriction, with minimum element a and maximum element b, we have PSPₘᵢₙ=0˜ₘ|a and PSPₘₐₓ=1˜ₘ|b. For contiguous masks, the spread depends only on the difference b−a. However, this is not true in the general case.

As discussed above, the gz-curve is used as a space filling curve for the Cartesian product T of N attribute domains of integers. The cardinality of each domain Dᵢ is a power of 2, and the way it participates in forming the element of the gz-curve is expressed by the domain mask m_{Di}.

As the gz-curve traverses the space T, fundamental regions Tᵣ of order r for r=0, . . . , n are rectangular boxes with volume 2^{r} corresponding to intervals of the gz-curve. Each T₀ region is a single point and Tₙ=T. The ends of the interval are aligned with the corresponding power of 2. Each fundamental region contains fundamental regions of lower orders. All the regions of a given order r are replicas of each other, and the shape of the gz-curve in them is the same. Their number in T is 2^{n+1-r}. When no confusion arises, corresponding intervals on the gz-curve will also be called fundamental.

A solution locus of a PSP on a gz-curve includes certain intervals or clusters, which, in some cases, degenerate to a point. A lacuna is the gap between the clusters, excluding gaps at the ends of the curve. Certain quantities characterizing the locus of a point PSP include the cluster count, cluster lengths, total lacunae length, and individual lacunae lengths.

In an example, m is an arbitrary mask projecting onto d dimensions, and {mᵢ} is its canonical partition. Then, x&m=p is a point PSP. Then, the locus of the PSP is 2^{n-d-tail(m)} of intervals of length 2^{tail(m)}, separated by lacunae of total length spread (m, PSP)−2^{n-d}. Interval lacunae lengths are the partial sums:

Σ_{i≧j}[2^{head(m}^{ᵢ}⁾−2^{tail(m}^{ᵢ}⁾].

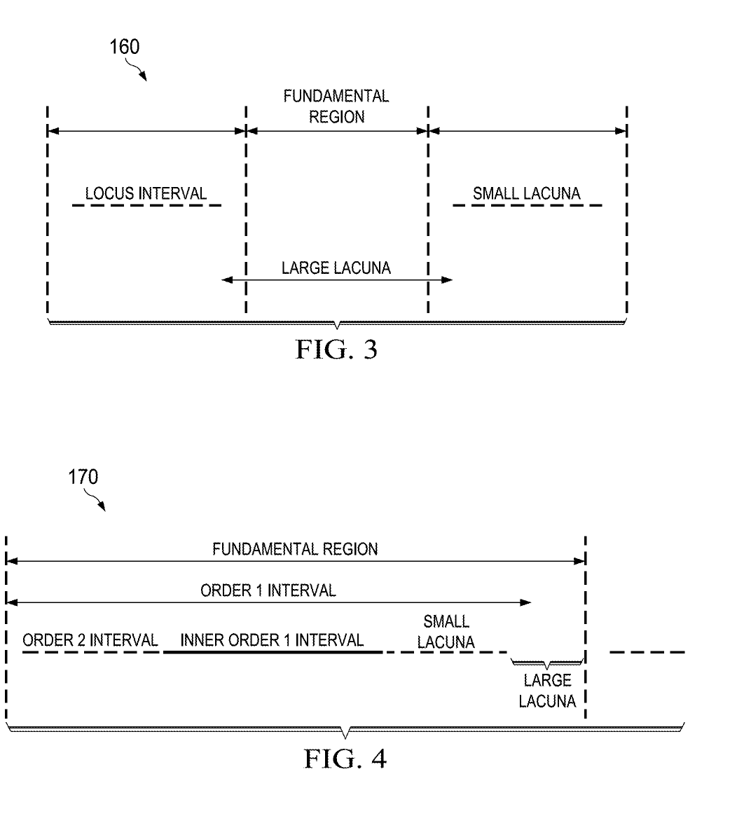

For a continuous mask with d bits, only one out of 2^{d} adjacent intervals of size 2^{tail(m)} within a fundamental region T_{head(m)} qualifies for the given fixed pattern restriction with mask m, and that one interval is also a fundamental region Tₜₐᵢₗ₍ₘ₎. There are also 2^{n-head(m)} such regions. Thus, the locus of points on the gz-curve satisfying the restriction is 2^{n-head(m)} clusters of length 2^{tail(m)} separated by lacunae of length 2^{head(m)}−2^{tail(m)}. FIG. 3 illustrates diagram 160 showing the structure of the locus for the point PSP.

Induction follows by repeating the base argument within each of the fundamental regions Tₜₐᵢₗ₍ₘ₎. Previously identified matching clusters are considered instead of S for the next component of the mask. The gaps at the edges of the regions are taken into account.

In an example, m is a mask projecting onto d dimensions, and p is an element of S(m). For a subset A⊂S, the fixed pattern search problem PSP(m, p) is finding all elements x⊂A such that x&m=p. Any mask partition {mᵢ} also induces pattern partition {pᵢ}. An element of A matches p on m if and only if it matches pᵢ on mᵢ for each i.

For the mismatch operation, the matcher examines PSP(mᵢ, pᵢ) one bit at a time. If x&mᵢ≠pᵢ, eⱼ is the most senior bit on which the sides disagree. The matcher returns j if x&mᵢ>pᵢ and −j if x&mᵢ<pᵢ. If x&mᵢ=pᵢ, the matcher proceeds to PSP(mᵢ₊₁,pᵢ₊₁), and so on. If no mismatch is detected, the matcher returns 0.

I is the identity mask on S, i.e. the mask projecting onto S.

For the hint operation, given an element x∈S and a mismatch at position j, if the mismatch is negative and indicates mismatch at position j, the matcher returns:

hint(x,j)=xⱼ|1_{I=j}|m_{m<j}|0˜_{m<j}.

The highest bit position that changes is j. Geometrically, this means that the point x belongs to some fundamental region Tⱼ₋₁ that does not intersect with the locus of the PSP. By changing the bit, the result is placed into the next such region. Since none of the bits above j is changed, it is within the same fundamental region Tⱼ that contained x.

If the mismatch is positive, the geometric meaning of the operation is similar, but the next fundamental region Tⱼ₋₁ intersecting with the PSP locus is located in a different fundamental region of higher order than the one containing x. To find such a region, the growth point gᵢ, the smallest position above j of an unset (0) bit in x&(^{˜}m)_{>j} is found. If such a position does not exist, the search is over, and ∞ is returned. Otherwise, the value of hint(x, g) is returned.

The number of times the frog jumps, N₁, may be estimated. The jump occurs only when a mismatch is detected and x belongs to some lacuna. After the jump, the frog lands on the next cluster. Hence, the number of jumps cannot exceed the number of lacunae, which is 2^{n-d-tail(m)}−1. If this number is less than R·card(A)·(1−2^{d-n}) the frog finishes ahead of the crawler. This holds for some masks, for example for contiguous headless masks, because for those, n=d+tail(m). In this example:

$$R > {R}_{1} ( m , A ) = \frac{{2}^{n - d - tail ( m )} - 1}{card ( A ) \cdot ( 1 - {2}^{d - n} )} .$$

In another estimate, there is a uniform distribution of A in S. Then, d_{A}=card(A)/card(S) is the average density of A. The expected number of points in all lacunae is d_{A}·(spread(m, PSP)−2^{n-d}). This may be rewritten as:

$$card ( A ) \cdot \frac{{2}^{n} - \overline{m} - {2}^{n - d}}{{2}^{n}} = card ( A ) \cdot ( 1 - {2}^{- d} - {22}^{- n} \overline{m} ) .$$

Thus, the estimate for N₁ may be rewritten as:

(1−2^{-d}−2⁻ⁿ m̅)<R·(1−2^{d-n}),

or as:

$$R > {R}_{2} ( m ) = \frac{1 - {2}^{- d} - {2}^{- n} \overline{m}}{1 - {2}^{d - n}} .$$

Scan-to-seek ratio R is less than 1, but R₂(m)<1. The minimum value of m̅ is achieved when m is a contiguous tailless mask projecting onto the d most junior bits. Thus,

$$min ( \overline{m} ) = {2}^{d} - 1 , \\ and$$

$$\begin{matrix}{R}_{2} ( m ) \leq \frac{1 - {2}^{- d} - {2}^{- n} ( {2}^{d} - 1 )}{1 - {2}^{d - n}} \\ = \frac{( 1 - {2}^{d - n} ) ( {2}^{- d} - {2}^{- n} )}{1 - {2}^{d - n}} \\ = 1 - {2}^{- d} \\ < 1.\end{matrix}$$

In an example, m is a mask projecting onto d dimensions or bits of S, and A is a nonempty subset of S. Then, R₁(m, A) is defined as:

$${R}_{1} ( m , A ) = \frac{{2}^{n - d - tail ( m )} - 1}{card ( A ) \cdot ( 1 - {2}^{d - n} )} .$$

Also, R₂(m) is defined as:

$${R}_{2} ( m ) = \frac{1 - {2}^{- d} - {2}^{- n} \overline{m}}{1 - {2}^{d - n}} .$$

If the scan to seek ratio of the data store satisfies the estimate R>min(R₁(m, A), R₂(m)), then the frog strategy is likely to win over the crawler strategy. In an example, the grasshopper method verifies this condition. If it holds, the threshold is set to 0, and the grasshopper will follow the frog.

However, the grasshopper has additional options for winning over the crawler. Jumps only occur if the matcher detects a non-zero mismatch, which happens when the current element x∈A belongs to a lacuna between clusters of the locus of the PSP. The grasshopper method determines that the lacuna is large enough to contain sufficient number of elements of A, so that, when it jumps to the next cluster, it skips over them. If a lacuna is large enough to contain X elements, the grasshopper will skip over X−1 of them when it encounters the first element of the lacuna, while the crawler visits every element. Comparing the crawler method and the grasshopper strategy involves comparing X·N₂cost(scan) and N₂·cost(Seek). The grasshopper wins when X>1/R. The grasshopper determines whether, given the scan to seek ratio R, there are lacunae of sufficient length that contain no fewer than X elements.

If the elements of A are uniformly distributed, the average number of elements of A in a lacuna of length L is estimated as d_{A}·L. Hence, lacunae should have a length larger than 1/(d_{A}·R). Partial sum series of the individual lacunae lengths are evaluated starting from the last element of the partition {mᵢ} until the sum is larger than 1/(d_{A}·R). If this occurs for element mⱼ, the value t=tail(mⱼ) is set as the threshold. If the sum never becomes large enough, the grasshopper method sets the threshold to n and acts as a crawler. Both d_{A} and R may be computed in advance.

In an example, m is a mask projecting onto d dimensions or bits of S with canonical partition {mᵢ}, where A is a nonempty subset of S. Also, R is the scan-to-seek ratio of the data store and j₀ is the minimal value of j for which the partial sum exceeds

$$\frac{{2}^{n}}{card ( A ) \cdot R} .$$

If a value j₀ exists, the grasshopper method with threshold t=tail(mⱼ₀) is likely to win over the crawler method.

If the matcher returns a negative mismatch value −y for an x, x belongs to a lacuna within a fundamental region T_{y} and the next cluster of the PSP locus is located in the same fundamental region. If the mismatch is positive, x is in a larger lacuna located between two fundamental regions of order higher than y. Thus, the grasshopper could have operated two different thresholds and jumped more often upon encountering a positive mismatch.

In another embodiment, the scanning portion is enhanced by determining, upon seeing an element that qualifies, the end point of the cluster, in the PSP locus, to which it belongs. Then, the method blindly picks the elements encountered before that end point. This means that, instead of verifying the match, the inequality is verified. These two operations have roughly the same cost. Upon encountering an element that does not satisfy the inequality, whether it matches the pattern is still verified. Calculating the end of the cluster is easy but bears an additional costs. Its efficiency depends on how the storage interface is implemented.

One embodiment method is for the partitioned case. If the data is partitioned and partitions are scanned in parallel, the grasshopper method has additional benefits from determining a threshold specific to a particular part.

When a partition is factorizable, there is a common pattern for all elements. In one example, there is partitioning by intervals. If an interval L in S is factorizable, there is a common prefix pattern P and a corresponding prefix mask M_{L} projecting on d_{L} dimensions, such that L=P|L′, where L′ is an interval in an (n−d_{L})-dimensional space. Prefix compression techniques may be used by some stores to keep a single copy of the prefix and only n−d_{L} bits per key. If the store also provides access to truncated keys with dimensionality reduction, efficiency increases. If such access is unavailable, the store performs multiple memory allocations and copies to assemble full-length keys.

Computing the prefix from the boundaries of L is reasonable, and additional reductions are possible. For example, the form may be:

S′=S(m)∩S(M_{L}),

which is achievable through a mask operation. If S′≠Ø, m′ is the corresponding intersection mask. If p_{m′}≠P_{m′}, the entire interval L lies outside the PSP locus as a trivial mismatch, and may be skipped. Then, if m′=m:

S(M_{L})⊂S(m),

and hence the entire interval L lies within the PSP locus as a trivial match, so the points in it are added to the bag without checking. Otherwise, the mask in PSP can be replaced with m″=m\m′, and the pattern is replaced with p_{m″}. When computing the threshold, the dimensionality n may be reduced by the dimensionality of S(M_{L}).

In another embodiment, there are range restrictions. In an example, pattern restrictions are of kind (R):

x&m∈[a,b].

First, an embodiment method checks whether a=b. When a=b, there is a point restriction, and when a does not equal b, there is a range restriction. Next, it is determined whether the interval is factorizable. The maximal common prefix p of a and b is computed. If such a common prefix exists, then:

[a,b]=[p|a′,p|b′]=p|[a′,b′],

and all points within the interval have the same prefix p. This induces splitting of mask m into prefix and suffix masks:

m=m_{prefix}|m_{suffix}.

The original PSP is transformed into a system of two PSPs:

x&m_{prefix}=p,

and:

x&m_{suffix}∈[a′,b′].

In an example, the locus of the original PSP is a subset of the locus structure. Hence, the partitioned case may be used. For range specific techniques, non-factorizable interval [a, b] may be considered.

Elements a and b have different senior bits, 0 and 1, respectively. Otherwise, they have a common prefix. An interval is complete if all bits of a are 0 and all bits of b are 1. For a complete interval, all elements of A are solutions.

An interval is suffix-complete if it is factorizable and its suffix interval [a′, b′] is complete. For example, interval [12, 15] is suffix-complete, because [12, 15]=12|[0, 3], but interval [11, 14] is not, because [11, 14]=8|[3,6]. For suffix complete intervals, the original range PSP is thereby converted into a point PSP.

Assuming that the interval is incomplete and nonfactorizable, it may still sweep almost the entire corresponding d-dimensional subspace. Hence, the PSP locus may be almost the entire space S. The smaller the interval, the closer to the point example, and the more opportunities there are for large lacunae to jump over.

The locus of the point PSP has intervals of equal length with gaps between them. This is not the case for range restrictions.

In a range example, m is an arbitrary mask projecting onto d dimensions and {mᵢ} is its canonical partition. Then, x&m=[a, b] is a range PSP, r is the cardinality of [a, b], and rᵢ is the cardinality of [aₘᵢ, bmᵢ]. Then, the locus of the PSP generally contains clusters of varying lengths, which are separated by lacunae of total length:

spread(m,PSP)−r·2^{n-d}.

The spread may be calculated as:

b|1_{˜m}−a|0_{˜m}+1.

Individual lacunae lengths are the partial sums:

Σ_{i≧j}[2^{head(m}^{ᵢ}⁾−rᵢ·2^{tail(m}^{ᵢ}⁾].

If mask m is contiguous, as in the point case, within each fundamental region T_{head(m)} in S, the locus of the PSP is a single interval of size r·2^{tail(m)}, where r=b−a+1 is the length of the interval. Thus, the lacuna between the intervals is:

2^{head(m)}−r·2^{tail(m)}.

In the non-contiguous case, unlike the point case, the partial PSPs for each of the masks are not independent. The second PSP depends on the state of the first problem. For example, for PSP1:

x&m₁∈[aₘ₁,bₘ₁].

In this example, x definitely solves the original PSP, and the PSP for the second mask is not considered. If x&m₁<aₘ₁ or x&m₁>bₘ₁, x is definitely not a solution. If x&m₁=aₘ₁ or x&m₁=bₘ₁, then x is a solution whenever it solves the second PSP, PSP2, of the form:

x&m₂∈[aₘ₂,1ₘ₂],

denoted by PSP2(a), or

x&m₂∈[0ₘ₂,bₘ₂],

denoted by PSP2(b). One or both of the corresponding intervals may degenerate to a point.

In an example, r₂(a) and r₂(b) are the lengths of the intervals for PSP2(a) and PSP2(b), respectively. Within each fundamental region T_{head(m1)}, the locus of PSP1 has a single interval of length r₁·2^{tail(m1)}, order 1 interval. The locus of the original PSP within that fundamental region is contained in that interval, and contains an interval of length:

(r₁−2)·2^{tail(m)}.

This corresponds to the inner part:

(aₘ₁,bₘ₁)=[aₘ₁+1,bₘ₁−1]

if the latter is not empty. Within the interval of order 1 but outside this inner part, in every fundamental region T_{head(m2)} there are two series of order 2 intervals corresponding to PSP2(a) and PSP2(b) located to the left and to the right, respectively, of the inner part of the order 1 interval. One of the order 2 intervals in each of two series are adjacent to the order 1 interval from the corresponding side, and the total number of intervals within that fundamental domain is at most:

2·(2^{tail(m1)-head(m2)}−1).

This is illustrated by locus structure 170 in FIG. 4.

If the mask has three components, the picture changes in a similar manner. Each of the order 2 intervals have their inner part belonging to the PSP locus. Within the space between the order 2 interval and its inner part has two series of order 3 intervals.

For the mismatch operation, the matcher examines each PSP(mᵢ, [aᵢ, bₛ]) one at a time. If x&mᵢ∈(aᵢ, bᵢ), the matcher returns 0, indicating a match. If x&mᵢ∉[aᵢ, bᵢ], rⱼ is the most senior bit on which they disagree. The matcher returns j if x&mᵢ>bᵢ and −j if x&mᵢ<aᵢ. If x&mᵢ=aᵢ or x&mᵢ=bᵢ, the matcher proceeds on to PSP(mᵢ₊₁, [aᵢ₊₁, bᵢ₊₁]) where the interval is [aₘᵢ₊₁, 1ₘᵢ₊₁] or [0ₘᵢ₊₁, bₘᵢ₊₁].

In an example, I is the identity mask on S, i.e. the mask projecting onto all of S.

For the hint operation, given an element x∈S and match position j, if the mismatch is negative, the matcher computes a preliminary hint h₁ of the form:

x_{I}_{_{>j}}|1_{I}_{₌ⱼ}0_{˜m}_{_{<j}}.

If the preliminary hint is not within [a, b], which depends on the seniority of x, the hint is corrected as:

h₁|aₘ_{_{<j}}.

The highest bit position that changes is j.

If the mismatch is positive, the matcher determines the growth point g, which is the smallest position above j of an unset (0) bit in x&m(˜m)_{>j}. If such a position does not exist, the search is over, and ∞ is returned. Otherwise, the hint is computed as above, with g instead of j.

Treatment of the partitioned case for range queries is similar to that for point queries, but for each interval in the partition, a proper range restriction is computed.

In another embodiment, set queries are performed. There are pattern restrictions of the kind (S): x&m∈E, where E is some set. In one example, the set is ordered. First, the spread of E is checked to determine if it is equal to its cardinality. If the spread of E is equal to the cardinality of E, E is a range. This also excludes single element sets.

Next, whether the set is factorizable is determined. The maximal common pattern p of all elements E is computed. If such a common pattern exists, then E=p|E′, and with the splitting of the mask, m=m_{common}|m_{residue}. The original PSP is transformed into a system of two PSPs, x&m_{common}=p and x&m_{common}∈E′. For the first problem, the locus structure is known, and the locus of the original PSP is a subset of it. The consideration for point queries is used. For set specific techniques, the non-factorizable set E is considered.

Because a set contains individual points, the locus of the set PSP is a union of loci of corresponding point PSPs. This suggests that all clusters in a PSPS locus have the same size and their total number differs from the point case by a factor of card(E). As in the range case, the solution space may be large if the set is almost the entire space S(m). Moreover, individual lacunae sizes differ greatly depending on the distances between the set elements. However, because the set is fully contained in the range [min(E), max(E)], estimates of the lacunae around the edges of the appropriate fundamental regions are similar to the range case. If they are not large enough to justify hopping, there is the option to look for sufficiently large lacunae corresponding to gaps between set elements.

The matcher does not split the locus of the set PSP into the union of the point PSP. Instead, the matcher splits the set PSP into similar partial set PSPs by components of the mask partition.

As in the range case, each next PSP depends on the state of the previous one. For the first PSP with the restriction x&m₁∈E₁, if x&m₁∉E₁, the search is immediately interrupted as a clear mismatch. If y=x&m₁∈E₁, further searching is reduced to the subset E₂(y) of E that matches y as the prefix. The next PSP would be x&m₂=E₂, where E₂=E₂(y)ₘ₂. The matcher keeps track of all such elements, and optionally the one immediately below them to determine the correct mismatch position. With each next PSP, the cardinality of Eᵢ quickly reduces.

Similarly, when providing hints, the match finds the appropriate smallest element to which it can move from the current position.

As in range PSPs, partitioning by intervals brings new aspects as, for a particular interval, the set PSP may morph into a range or point PSP.

In an additional embodiment, multiple simultaneous restrictions are handled. Because the locus of simultaneous PSPs is the intersection of the loci of the individual PSPs, the lengths of the lacunae are additive. Thus, it is possible to set a single threshold.

When there are multiple pattern restrictions of various kinds, the matcher starts by performing reductions for the pattern restrictions. The resulting fixed patterns, from point filters and from the factorization of the range and interval queries are combined into a single fixed pattern. The complete residual interval PSPs are eliminated. The matcher has a point PSP and/or multiple range and set PSPs. The matcher then employs individual matchers for each PSP and makes them compete for the highest mismatch position. When mismatch is given, the hint is computed to satisfy all restrictions at the same time. If the mismatch is negative, a preliminary hint is computed, and each individual matcher corrects it if necessary. When the mismatch is positive, all matchers compete for the lowest growth position, and then proceed as in a negative mismatch.

In an example, the grasshopper strategy is tested with various thresholds and compared to the crawler strategy, including with a threshold of 0 for a frog strategy. With a lower threshold, the number of hops increases at the expense of shorter jumps.

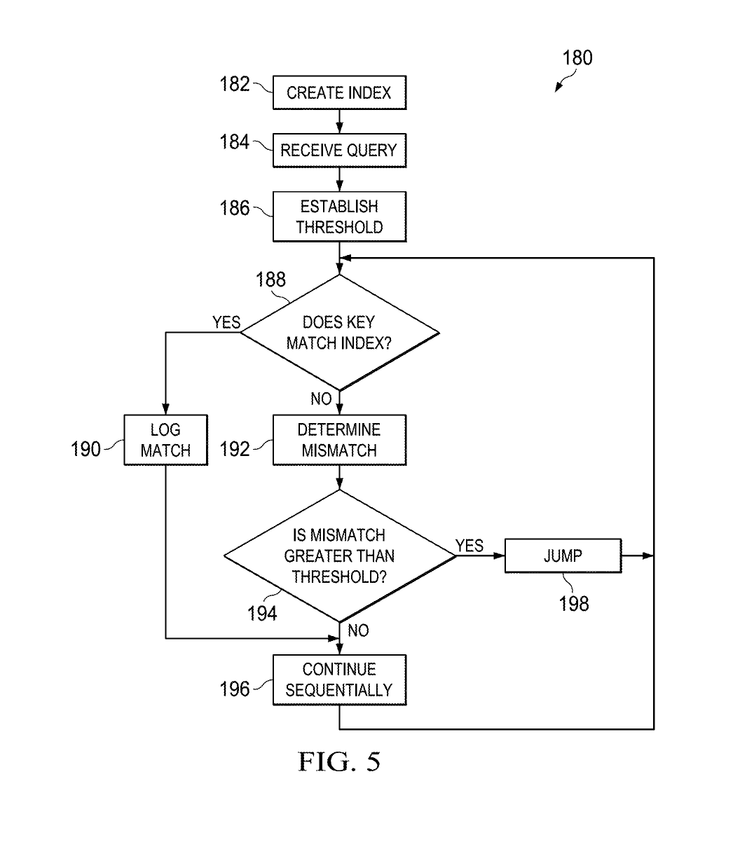

FIG. 5 illustrates flowchart 180 for a method of database searching. Initially, in step 182, an index is created. Data dictionaries on all relevant dimensional attributes are built, transforming each record into a composite key-value pair, which is then sorted by key, a very large integer represented by an array of bytes of fixed length. The keys may be composed using z-ordering. Key-value pairs are stored in the order of the keys. In an example, a composite key is encoded through integers obtained from components' dictionaries. In an example, bits are mixed together, where bits of one attribute may be placed next to bits of the next attribute.

Next, in step 184, the database receives a query. The query is received from a user. The query may have a point, range, or set filter on any attribute, as well as multiple combinations of such filters against customer data.

Then, in step 186, the database establishes a threshold. The threshold may depend on the scan ratio and density of the data set, where the threshold is computed for a data set. In one example, the threshold is determined for the individual query. The threshold may be different for point, range, and set queries. Alternatively, the threshold is independent of the individual query, based on the data set. In one example, the threshold is set to 0, and the method always jumps. In another example, the threshold is set to n, and the method always crawls. Alternatively, the threshold is set to an integer between 0 and n. A separate threshold may be set for a positive mismatch and a negative mismatch.

In step 188, the database determines whether the key matches the index. An example works directly with the key, not with components. A pattern search is performed. A generalized z-curve may be used, where there is a two dimensional square of little zs that form a larger z. There is a rectangular space with values for the composite keys, with vertical and horizontal lines in the rectangle. If the key matches the index, the system proceeds to step 190 to log the match. Then, the database continues to search sequentially for the next match in step 196, and returns to step 188. If the key does not match the index, the system proceeds to step 192.

In step 192, the database determines the mismatch. The mismatch may be positive or negative. The most senior bit where the key and the index disagree is determined, and this is the mismatch.

Next, in step 194, the database determines if the mismatch from step 192 is greater than the threshold established in step 186. If the mismatch is less than or equal to the threshold, the database continues searching sequentially in step 196. If the mismatch is greater than the threshold, the database jumps in step 198. When the projection of the current element onto the range space misses the range, the next match candidate is the closest element that projects onto the range start. However, the jump length is less than in the point pattern search. Indeed, if the range is almost all of the range space, almost all points in a given region fit the range.

The database jumps in step 198. The jump may be made in accordance with the last disqualified key. After jumping, it proceeds to step 188 to determine whether the key matches the index.

Example matcher code was is in Java with keys represented as byte arrays. Unsigned large integer arithmetic and bitwise operations are implemented. An applications programming interface (API) is used to create schema and query filters. A pluggable storage adapter interface enables to experiment with different data stores. The distributed data scenario and in-memory scenario are tested. A data store adapter for an in-memory scenario is based on a B+ tree and MVStore, a B+ tree based key-value store behind the open source H2 database. For the big data tests, Apache HBase, an open source distributed key-value store from the Hadoop family, is used. Within this adapter, grasshopper algorithms were invoked via the HBase coprocessor mechanism. HBase partitions data into key ranges or regions, each of which is assigned to a region server node. Coprocessors facilitate access to each region, which in turn facilitates partition based grasshopper strategies. Another coprocessor keeps track of statistics for every region.

For in-memory testing, a laptop with an i5 central processing unit (CPU) and 16 Gb of random access memory (RAM) running a 64 bit Windows 7 operating system is used. The data is either randomly generated on the fly or read from a file. The schema emulated call detail records (CDRs) like those produced in telecommunications. There are sixteen dimensional attributes ranging from 2 to 2¹⁴. The total composite key length is 116, resulting in 15 byte keys. A data set of 100 million records is used. The maximal Java heap size is 12 Gb. In-memory tests are run single-threaded.

For example, distributed storage tests, a configuration with 128 regions on 12 region server nodes running version 0.94 of HBase on Hadoop installed on a commodity Linux cluster is used. Several data sets are used, including one with the CDR schema and 150 million records, one with 10 attributes and 1.46 million records, and a Transaction Processing Performance Council Decision Support (TPC-DS) benchmark data set with 5 attributes and 550 million records. Queries were expressed in structured query language (SQL) as SELECT COUNT(1) FROM dataset WHERE filter, with filter being a point, range, or set restriction on some of the dimensional attributes of the data set. Query filter values are randomly generated on the fly. For the in memory scenario, exhaustive combinations of queries for up to three attribute filters with point, range, and set restrictions were performed. For the big data scenario, attributes were chosen randomly. Each query was run 10 times, using the crawler and grasshopper strategy with different thresholds. The smallest and largest run times were eliminated, and the remaining runs were averaged for each strategy. The average over all combinations was computed.

Odometer key composition strategies for leading attributes produce very low latencies. For other cases, the grasshopper uses pure crawling. The grasshopper strategy is efficient overall. For ad-hoc queries single bit interleaving in the decreasing order of attribute cardinalities produces better results. In many cases, the ad-hoc queries on every attribute are sped up. Improvements over full scan for any gz-curve composition kind are provided, but not necessarily for each attribute.

As dimensionality grows, the number of attributes that can take advantage of grasshopper techniques may be limited to those whose mask heads are sufficiently high. The number t of useful bits in the key is roughly log₂(card(A) R). Thus, setting the threshold to n−t is close to the best option. Those t bits may be distributed between the most popular attributes.

In an example, the best results are achieved for the grasshopper. For in memory data sets, the frog is on average 3-5 times slower than the crawler, while the grasshopper is faster than the crawler. For distributed data sets, both the frog and the grasshopper outperform the crawler by orders of magnitude. With an optimal threshold, the grasshopper is 6.5% faster than the frog on the CDR data set and 13% faster on the TPC-DS data set. For a 1.45 billion records data set both strategies coincide, with a threshold of 0.

The grasshopper with an appropriately chosen threshold does not lose to the crawler.

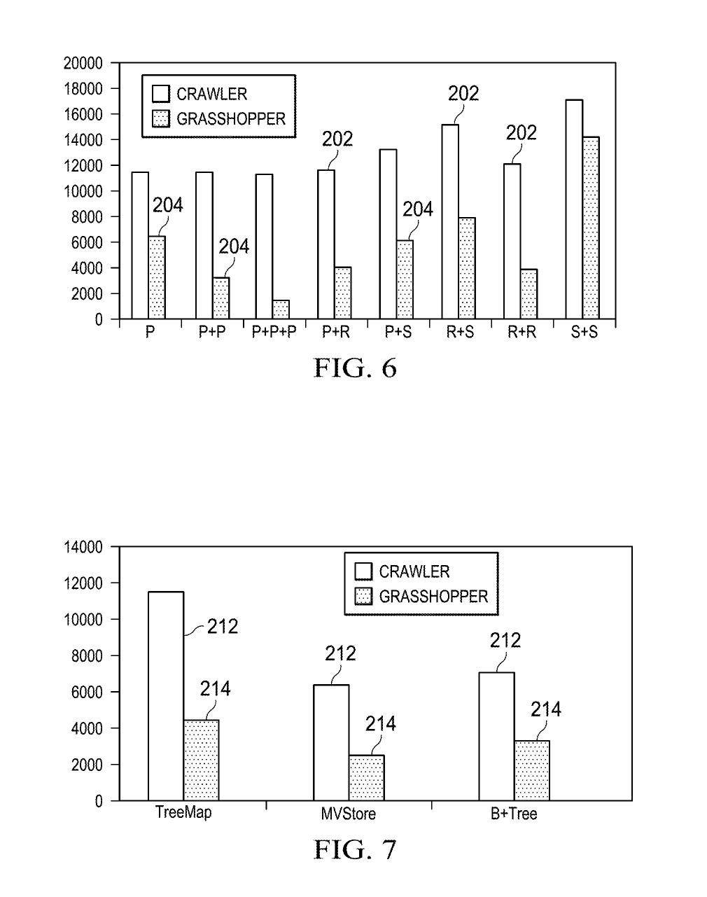

FIG. 6 illustrates a graph of query time in ms with TreeMap as the data store for crawler 202 and grasshopper 204. Combinations of filters include point (P), range (R), and set (S) restrictions in 16 dimension for a 100 million rows data set. The results are measured using exhaustive combinations. The frog (not pictured) is on average 4.3 times slower than the crawler. The more restrictions there are, the larger the performance gains of the grasshopper strategy.

FIG. 7 illustrates a graph comparing query times between in-memory data stores for crawler 212 and grasshopper 214. All data stores significantly benefited from using the grasshopper strategy. The query times, in ms, with TreeMap, MV-store, and basic B+ Tree are shown for data stores with single point filters on 16 dimensions with 100 million rows in a data set. The results are measured using exhaustive combinations. The frog (not pictured) is at least 3.8 times slower than the crawler.

For the in-memory tests, the theoretically computed threshold for grasshopper jumps is the best in the majority of the cases. The scan-to-seek ratio R was measured to range from 0.35 to 0.8 for in-memory data stores. For the 100 million CDR data set, the theoretical threshold was close to 95. Thus, 21 (116−95) key bits were useful, and all 16 dimensions could benefit from the grasshopper strategy.

In one example, the optimal threshold value for the 150 million CDR data sets is 64, with 52 useful bits.

In HBase, region data is split internally into blocks. Skipping over a block is beneficial, but block statistics are not accessible from the coprocessor. Searches within the blocks are sequential, so the seek operation is very slow unless it skips over entire blocks.

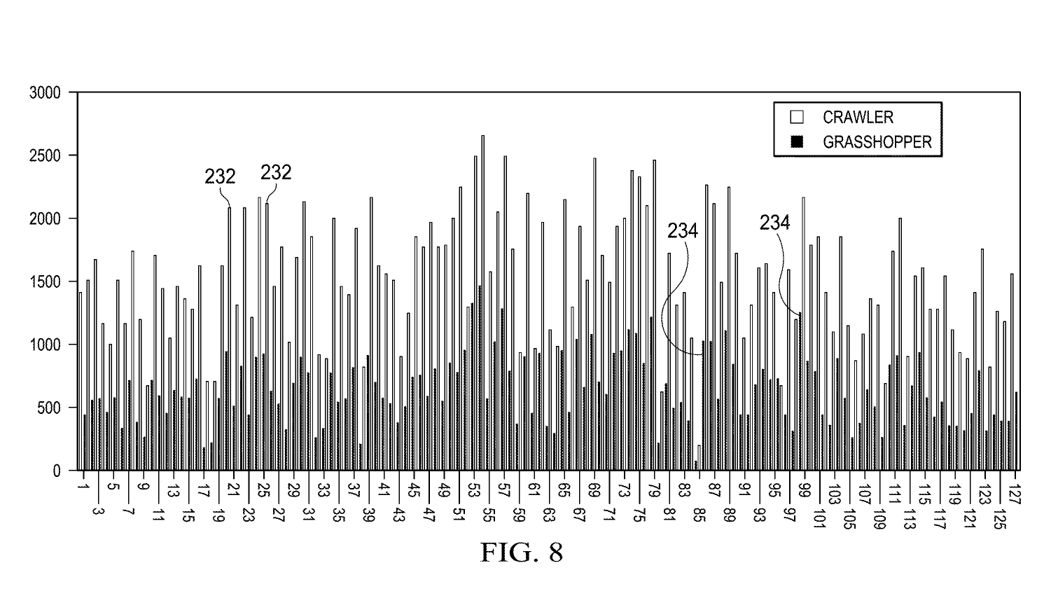

The time of query completion is determined by the slowest node. If data is not evenly distributed, the results are less predictable. Test times for both strategies per region on the CDR data set are illustrated by FIG. 8, which shows crawler 232 and grasshopper 234 results. Query time in ms per HBase region with HBase as the data store for single point filters on 16 dimensions and 150 million rows of data set measured using random combinations is pictured. The frog (not pictured) is on average 6.5% slower than the grasshopper.

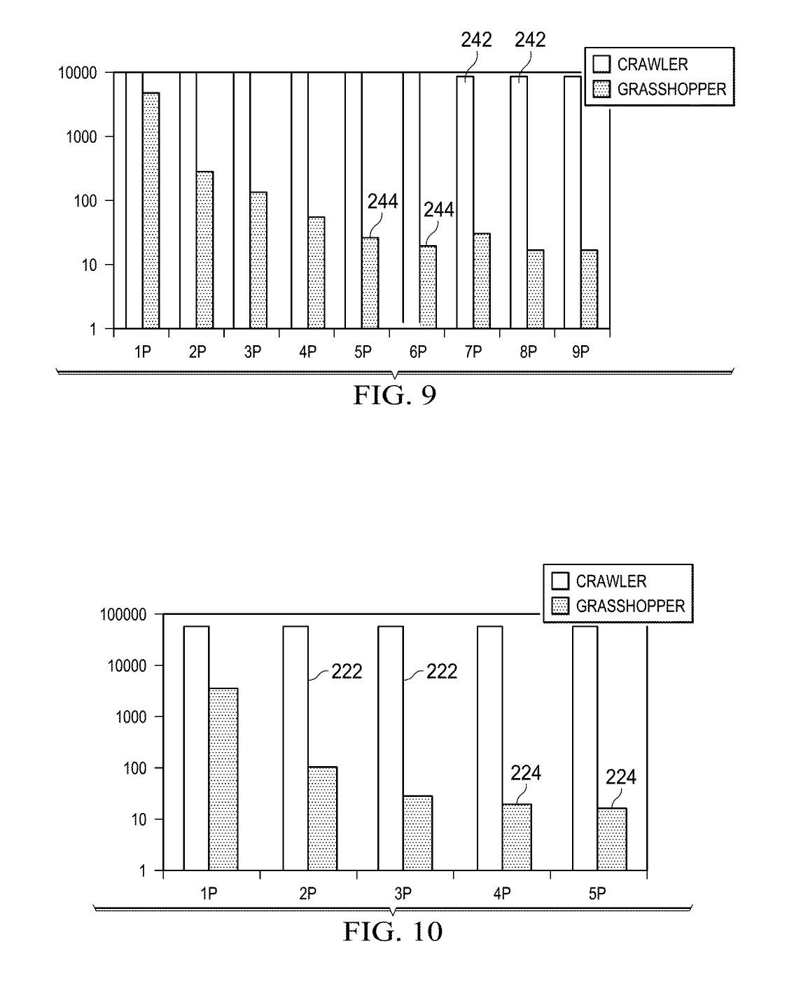

FIG. 9 shows the results for the TPC-DS data sets for crawler 242 and grasshopper 244. The graph shows the query time in ms on a logarithmic scale using HBase as the data store for single and multiple point filters on five dimensions with 550 million rows of TPC-DS data set. The frog (not pictured) is on average 13% slower than the grasshopper.

FIG. 10 illustrates the results for 1.45 billion record sets for 222 crawler and 224 grasshopper. The graph shows the query time in ms on a logarithmic scale using HBase as the data store for single and multiple point filters on 10 dimensions for a 1.46 billion rows data set. The threshold is 0, so the grasshopper and frog strategies coincide.

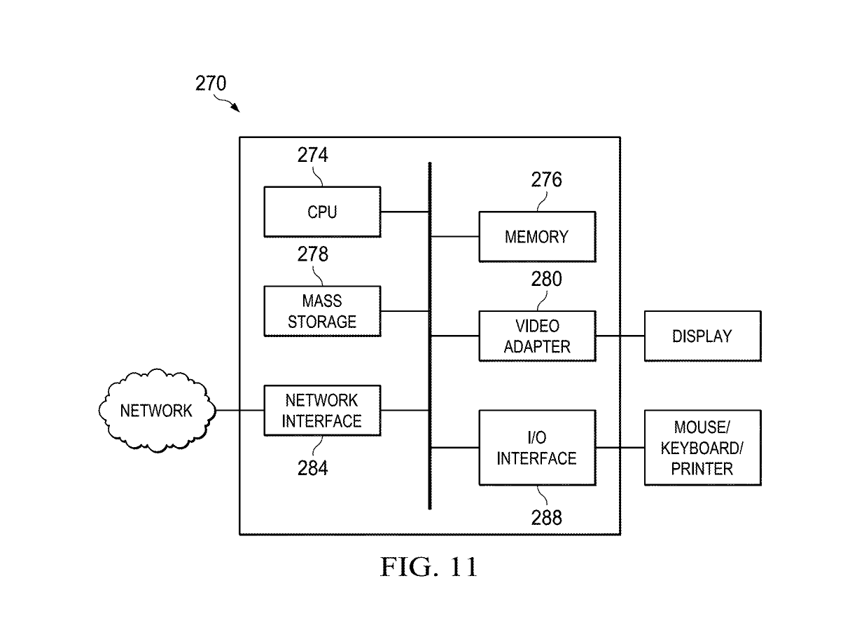

FIG. 11 illustrates a block diagram of processing system 270 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input devices, such as a microphone, mouse, touchscreen, keypad, keyboard, and the like. Also, processing system 270 may be equipped with one or more output devices, such as a speaker, a printer, a display, and the like. The processing unit may include central processing unit (CPU) 274, memory 276, mass storage device 278, video adapter 280, and I/O interface 288 connected to a bus.

The bus may be one or more of any type of several bus architectures including a memory bus or memory controller, a peripheral bus, video bus, or the like. CPU 274 may comprise any type of electronic data processor. Memory 276 may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

Mass storage device 278 may comprise any type of storage device configured to store data, programs, and other information and to make the data, programs, and other information accessible via the bus. Mass storage device 278 may comprise, for example, one or more of a solid state drive, hard disk drive, a magnetic disk drive, an optical disk drive, or the like. The mass storage device can include a hardware data compression circuit boards or the like.

Video adaptor 280 and I/O interface 288 provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not pictured) may be used to provide a serial interface for a printer.

The processing unit also includes one or more network interface 284, which may comprise wired links, such as an Ethernet cable or the like, and/or wireless links to access nodes or different networks. Network interface 284 allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method for searching a database, the method comprising:
receiving, by a processor from a user, a message, indicating a query, wherein the query comprises a pattern;
determining, by the processor, a first threshold in accordance with a data set of the database;
comparing, by the processor, the pattern to a first key of the data set to produce a comparison; and
determining, by the processor, whether to jump to a second key of the data set or scan to a third key of the data set in accordance to the comparison and the first threshold comprising
jumping to the second key of the data set when an absolute value of the comparison is greater than the first threshold, and
scanning to the third key of the data set when the absolute value of the comparison is less than or equal to the first threshold, wherein the first key and the third key are sequential.

2. The method of claim 1, further comprising generating an index in accordance with the data set.

3. The method of claim 2, wherein generating the index comprises transforming a plurality of records of the data set into a plurality of composite key-value pairs.

4. The method of claim 1, wherein determining the first threshold comprises determining the first threshold in accordance with a seek-scan ratio of the data set and a density of the data set.

5. The method of claim 1, wherein determining the first threshold comprises determining the first threshold in accordance with the query.

6. The method of claim 1, wherein the query comprises a point filter.

7. The method of claim 1, wherein the query comprises a range filter.

8. The method of claim 1, wherein the query comprises a set filter.

9. The method of claim 1, wherein the query comprises a first point filter and a second point filter, a first range filter and a second range filter, a first set filter and a second set filter, the first point filter and the first range filter, the first point filter and the first set filter, or the first range filter and the first set filter.

10. The method of claim 1, wherein the data set is partitioned.

11. The method of claim 1, wherein the data set is not partitioned.

12. The method of claim 1, wherein comparing the pattern to the first key of the data set comprises reducing a number of bits of the pattern.

13. The method of claim 1, wherein determining the first threshold comprises setting the first threshold to 1.

14. The method of claim 1, wherein determining the first threshold comprises setting the first threshold to an integer greater than 1.

15. The method of claim 1, further comprising determining a second threshold in accordance with the data set, wherein determining whether to jump or scan comprises comparing the comparison to the first threshold when the comparison is negative and comparing the comparison to the second threshold when the comparison is positive.

16. A method for searching a database, the method comprising:
receiving, by a processor from a user, a message indicating a query, wherein the query comprises a pattern;
comparing, by the processor, the pattern to a first key of a data set of the database to produce a comparison;
logging, by the processor, a result in accordance with the comparison to produce a logged result;
determining, by the processor, whether to jump or scan sequentially in accordance with the comparison; and
transmitting, by the processor to the user, the logged result.

17. The method of claim 16, wherein the pattern comprises a point filter.

18. The method of claim 16, wherein the pattern comprises a range filter.

19. The method of claim 16, wherein the pattern comprises a set filter.

20. The method of claim 16, wherein the pattern comprises a first point filter and a second point filter, a first range filter and a second range filter, a first set filter and a second set filter, the first point filter and the first range filter, the first point filter and the first set filter, or the first range filter and the first set filter.

21. The method of claim 16, wherein determine whether to jump or scan comprises comparing the comparison to a threshold.

22. A computer comprising:
a processor;
a database comprising a multidimensional database index; and
a computer readable storage medium storing programming for execution by the processor, the programming including instructions to
receive, from a user, a message, wherein the message indicates a query, and wherein the query comprise a pattern,
determine a first threshold in accordance with a data set of the database,
compare the pattern to a first key of the data set to produce a comparison, and
determine whether to jump to a second key of the data set or scan to a third key in the data set in accordance to the comparison and the first threshold, comprising
jump to the second key of the data set when an absolute value of the comparison is greater than the first threshold, and
scan to the third key of the data set when the absolute value of the comparison is less than or equal to the first threshold, wherein the first key and the third key are sequential.
